(19) United States
(12) Patent Application Publication
(10) Pub. No.: US 2026/0153160 A1
(43) Pub. Date: Jun. 4, 2026

(54) NATURAL GAS REGULATOR WITH LIMITED INTERNAL RELIEF VALVE

(71) Applicant: Cavagna Group SpA, Brescia (IT)

(72) Inventor: Giuliano Cavagna, Brescia (IT)

(73) Assignee: Cavagna Group SpA, Brescia (IT)

(21) Appl. No.: 19/407,695

(22) Filed: Dec. 3, 2025

Related U.S. Application Data
(60) Provisional application No. 63/727,281, filed on Dec. 3, 2024.

(51) Int. Cl. F16K 17/04; G05D 7/01

(52) U.S. Cl. CPC F16K 17/048; G05D 7/0113

(57) ABSTRACT

An internal relief valve assembly for use with a natural gas regulator having a diaphragm, a piston, a valve stem and an inlet for receiving gas. A first spring surrounds the valve stem and is centered in the diaphragm. A second spring is nested within the first spring for controlling when the internal relief valve opens. A square-ring is positioned within an opening within the valve stem. A first channel is formed in the valve stem and a second channel is formed in the valve stem which is substantively perpendicular to the valve stem and connected to the first channel to circulate the flow of gas through the valve to an outlet.

### CLAIM OF PRIORITY

The application claims priority to Provisional Patent Application Ser. No. 63/727,281, filed on Dec. 3, 2024, the entirety of which is hereby incorporated by reference.

### BACKGROUND OF THE DISCLOSURE

The disclosure relates to natural gas regulators. More particularly, it relates to Internal Relief Valves (IRV) used with single stage and dual stage gas regulators.

Internal Relief Valves (IRV) used on natural gas regulators are extremely common and all operate similarly. The primary purpose of the IRV is to vent gas in the event of regulator failure or upset condition. So if the regulator fails or downstream pressure increases to an unsafe level for any reason, the IRV will start to release gas to the atmosphere so high pressure gas doesn't go into a home or building. For a typical regulator used for most homes, the IRV is a safety feature that protects the home in the event of a failure. Up until recent years, the IRV was designed to have as much capacity as possible to increase safety. That is changing as reducing emissions has become a priority.

Many gas companies are looking to reduce vent emissions by limiting the vent flow rate to 2.5 Standard Cubic Feet per Hour (SCFH) or less, in accordance with current North American standards. Limiting the flow to 2.5 SCFH not only minimizes emissions, but also allows for easier installation. 2.5 SCFH is the vent rate limit found in the CSA 6.22/ANSI Z 21.80 standard that is used for indoor regulators that would be found on water heaters, furnaces or other appliances. These must have a small vent rate to prevent gas from reaching the explosive limit.

Vent limiters are typically used to achieve 2.5 SCFH or less. Vent limiters are devices that screw into the regulator vent and limits the flow through the vent. These are typically very safe, but a problem with vent limiters is they result in it being harder for the regulator diaphragm to move up and down which diminishes regulator performance. Vent limiters are also typically limited to indoor installations to prevent freezing. The vent limiter is mainly used to limit gas venting in the event of a diaphragm tear.

Thus, there is a need to use an IRV to limit the flow rate to 2.5 SCFH or less without limiting regulator performance or diaphragm travel and allowing the IRV to still vent small amounts of gas to prevent activation or intervention of additional safety equipment.

### SUMMARY OF THE DISCLOSURE

The disclosure relates to Internal Relief Valves used with gas regulators. Internal relief valves release a small amount of gas through a vent during an overpressure event. When pressure decreases back to normal levels, the IRV re-seats, stopping the release of gas. This protects the regulator from brief pressure surges, such as thermal expansion. Below is a summary of the different types of IRVs commonly used in the market today:
IRV (Standard) (FIG. 5)—a full capacity IRV. This IRV typically is used on smaller (single-stage) regulators used with residential and commercial buildings.
This IRV is designed to keep outlet pressure below the system maximum allowable operating pressure (MAOP). A standard IRV typically has a ¾ inch or 1 inch vent and is commonly used on regulators with 1.25 inch (or smaller) bodies.
Token IRV (FIGS. 6 and 7)—T his IRV is typically used as an alarm which users hear or smell to indicate there is an issue with the regulator. This style of IRV is not a full safety device, so the regulator will typically have a backup regulator (monitor), a slam shut valve (SSV), or an independent relief valve. Refer to FIG. 6, a diaphragm assembly with token IRV has a spring 2 and a diaphragm 3 (with retainer or diaphragm plate 4).
High Capacity IRV—A high capacity IRV can have with a 2.5 inch vent and is used on larger regulators (i.e. 1.5 inch or 2 inch).
Limited IRV (FIGS. 8 & 9)—Similar to a token internal relief valve, but the relief capacity capable by this IRV is restricted to 2.5 SCFH or less at a specified pressure. The Limited IRV functions the same as the standard IRV, but has been designed to minimize emissions. Since the Limited IRV does not provide safety, the limited IRV can be used to keep emissions at or below 2.5 SCFH until another safety device intervenes. The Limited IRV is designed to limit the release of gas to ≤2.5 SCFH until the safety device activates. These IRVs are designed to release limited amounts of gas during minor upset scenarios. They do not provide over pressure protection and have no impact on normal regulator operation. The advantage of having this for an outdoor installation is that the Limited IRV can be installed closer to windows, electric panels, HVAC intakes or other ignition sources than other types of Internal Relief Valves.

In accordance with one aspect of the disclosure, an internal relief valve assembly is used with a natural gas regulator having a diaphragm, a piston, a valve stem and an inlet for receiving gas. A first spring surrounds the valve stem and is centered in the diaphragm. A second spring is nested within the first spring for controlling when the internal relief valve opens. A square-ring is positioned within an opening within the valve stem and a first channel is formed in the valve stem. A second channel is formed in the valve stem which is substantively perpendicular to the valve stem and connected to the first channel to circulate the flow of gas through the valve to an outlet.

In accordance with another aspect of the disclosure, an internal relief valve has a valve stem, a bushing surrounding an outer portion of the valve stem, a square-ring positioned in an opening formed around the outer portion of the valve stem, a first channel formed in the valve stem which extends within a central portion of the valve stem along a longitudinal axis of the valve stem, a second channel formed in the valve stem perpendicular to and connected to the first channel to circulate gas flow through the valve stem to an outlet of the gas regulator.

In accordance with another aspect of the disclosure, a regulator has a control spring and a second spring or IRV spring nested inside a control spring. The control spring controls the delivery pressure of gas exiting the regulator. The IRV spring, nested inside the control spring, is what controls when the IRV will open. If outlet pressure rises above the IRV set point, then the IRV spring will compress and allow the diaphragm plate to lift away from the stem. Once the diaphragm plate lifts from the stem, gas can travel through the center of the diaphragm plate and flow out of the regulator vent.

In accordance with another aspect of the disclosure, an opening in the diaphragm plate of the IRV is much smaller than normal. This is only possible because there is a separate safety device for the system.

In accordance with another aspect of the disclosure, a limited IRV has a reduced flow area to reduce the flow rate of the IRV.

In accordance with another aspect of the disclosure, a limited IRV is used to reduce the flow rate to 2.5 SCFH or less.

Still other aspects of the disclosure will become apparent upon a reading and understanding of the following detailed description

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a front view schematic diagram of a natural gas dual stage regulator with a token Internal Relief Valve in accordance with one embodiment of the disclosure;

FIG. 2 is a side view schematic diagram of the regulator of FIG. 1;

FIG. 3 is a schematic illustrating operation of the regulator of FIG. 1;

FIG. 4 is a schematic diagram of token IRVs in closed and opened positions.

FIG. 5 is a schematic diagram of a single stage gas regulator with a standard IRV in accordance with another embodiment of the disclosure.

FIG. 6 is a side elevational view of a single diaphragm with a token IRV in accordance with another aspect of the disclosure.

FIG. 7 is a side elevational view of a dual diaphragm with a token IRV in accordance with another aspect of the disclosure.

FIG. 8 is a side elevational view of a dual diaphragm with a limited IRV featuring a flow limiting bushing in accordance with another aspect of the disclosure.

FIG. 9 is a side elevational view of a limited IRV with a quad-ring and valve stem with channels in accordance with another aspect of the disclosure.

FIG. 10 is a side elevational view of a diaphragm and IRV of FIG. 9 used with a dual stage regulator.

FIG. 11 is a side elevational view in cross section of the IRV valve of FIG. 10.

### DETAILED DESCRIPTION OF THE PREFERRED EMBODIMENTS

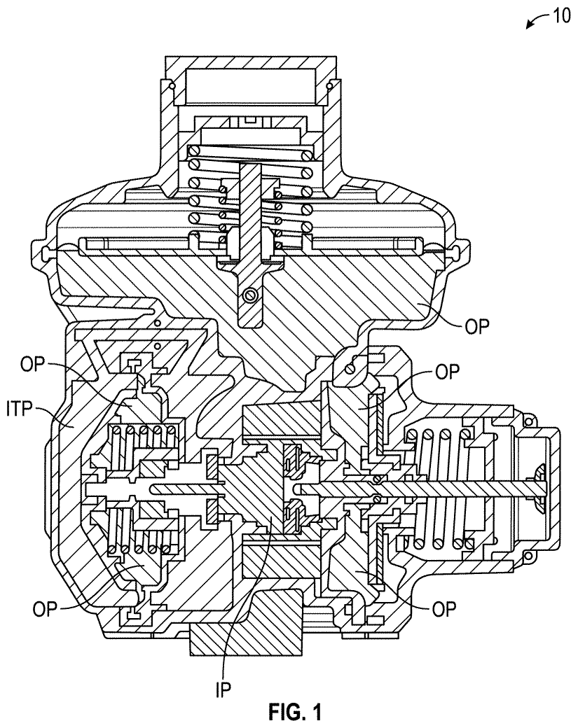

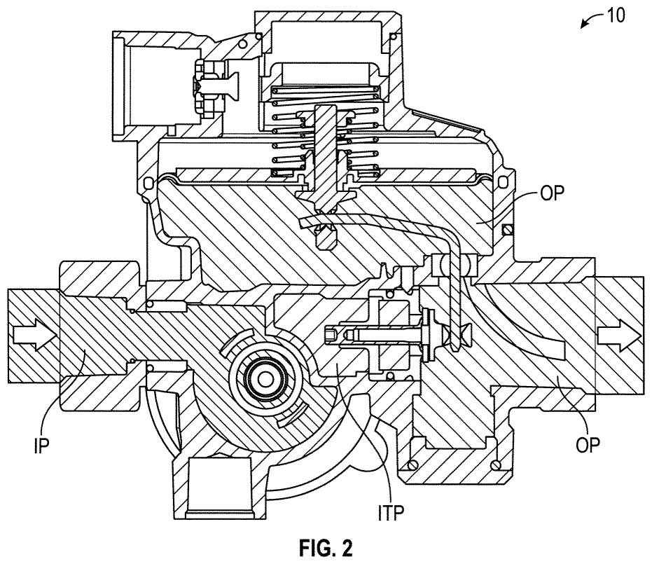

Referring now to FIGS. 1-3, a dual stage regulator 10 in accordance with an embodiment of the present disclosure is shown. The regulator 10 is a direct acting, dual-stage pressure regulator with an integral slam-shut valve (SSV) and an optional token IRV. Additional safety features available can include over pressure shut off valve (OPSO), under pressure shut off valve (UPSO) and an excess-flow shut off valve (EFV).

The gas regulator is a direct acting, dual-stage pressure regulator with an integral slam-shut valve (SSV) and an optional token Internal Relief Valve (IRV). The regulator features a variety of body configurations, end connections, and integral safety options. The available safety options include over pressure shut off (OPSO) device, under pressure shut off (UPSO) device and excess-flow shut off (EFV).

Here are some typical features of the gas regulator:

FIGS. 1-3 illustrates an inlet pressure (IP), an intermediate pressure (ITP) and an outlet pressure (OP). The regulator is available with an optional token IRV or a Limited IRV. The limited IRV can be used to keep emissions at or below 2.5 SFCH until the OPSO activates.

The regulator 10 has a valve stem 12 and an inlet 14 for receiving gas and an outlet 16 for delivering gas to an end-user facility.

The regulator includes a diaphragm 20, a piston 22 and a spring 24 as part of the integral slam-shut valve (SSV). Movement of the UPSO spring 24 (and outer OPSO spring 21) as a result of changes (increase/decrease) of the outlet pressure (OP) allows the diaphragm to move up and down releasing the SSV stem 22 and stopping the flow of gas. Intermediate pressure (ITP) passes through another orifice where piston 25 and disk 26 assembly and a control arm 27 transfers the diaphragm assembly 36 movement to control the flow of gas to the outlet regulator.

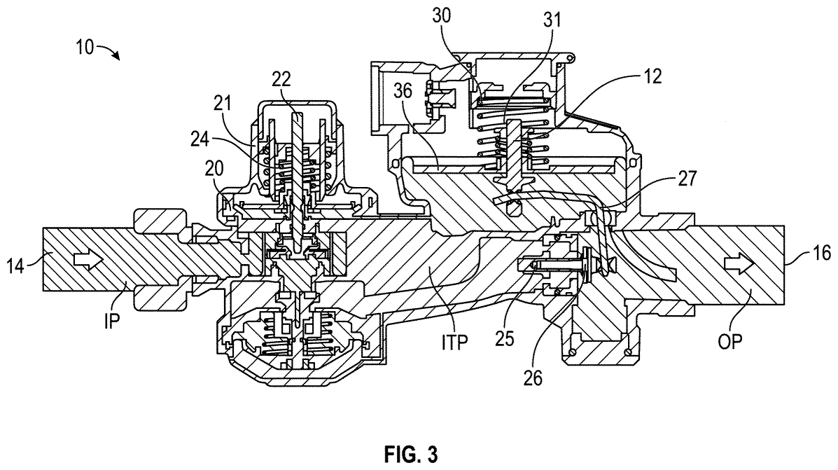

Control spring 30 surrounds valve stem 12 which is centered in the diaphragm assembly 36. An increase in outlet pressure compresses the spring 30 and the IRV spring 31 thus lifting the diaphragm assembly away from the IRV seat thus allows the gas (outlet pressure (OP)) to travel through center of the diaphragm assembly 36 to an outlet vent (FIG. 3).

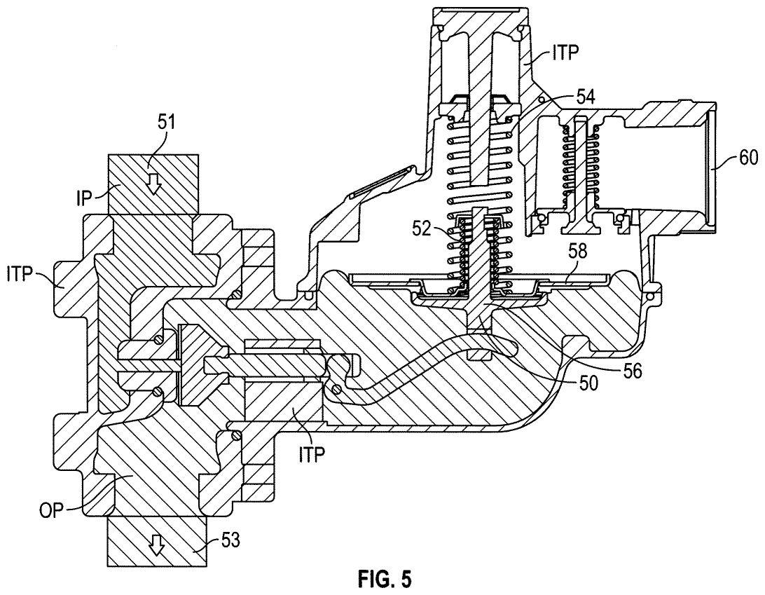

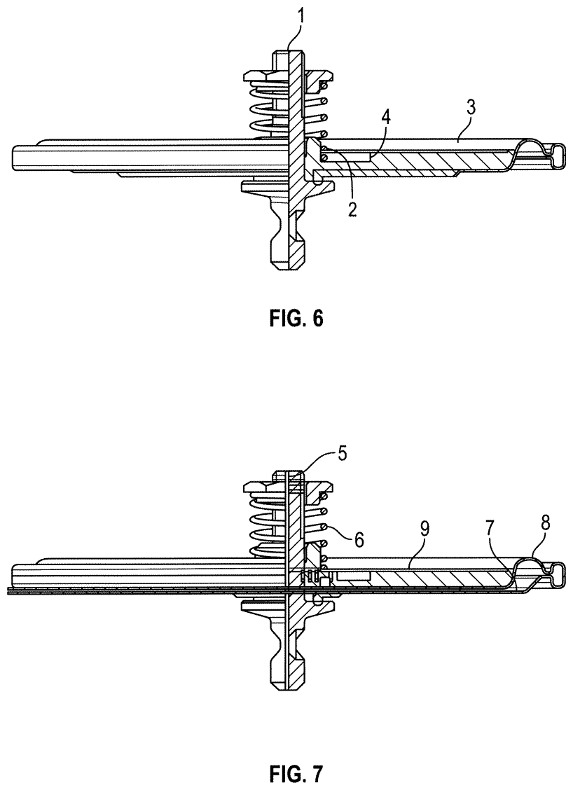

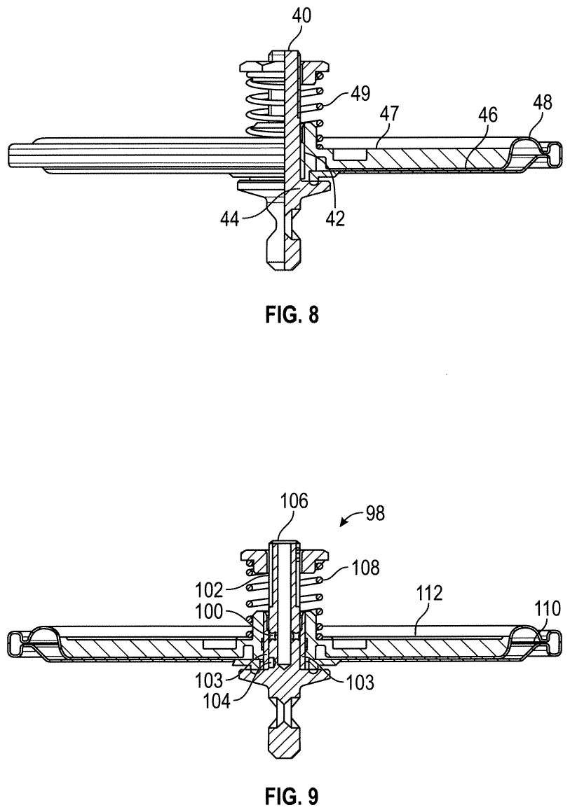

A single stage regulator in accordance with an embodiment of the present disclosure is shown in FIG. 5. The regulator is a direct acting, single-stage pressure regulator shown with a standard Internal Relief Valve (IRV). A limited IRV could also be used with the single stage regulator of FIG. 5. The regulator features a variety of body configurations, end connections, and optional safety options. Available safety options may include over pressure shut off (OPSO) device, under pressure shut off (UPSO) device and excess-flow shut off (EFV).

An inlet pressure (IP) and an outlet pressure (OP) are shown.

The regulator has a valve stem 56 and an inlet 51 for receiving gas and an outlet 53 for delivering gas to an end-user facility.

A second spring 52 is nested inside control spring 54. The control spring 54 controls the delivery pressure of gas exiting the regulator. The IRV spring 52, nested inside a control spring, is what controls when the IRV will open. If outlet pressure (OP), shown in the region below in the diaphragm, rises above the IRV set point, then the IRV spring 52 will compress and allow the diaphragm plate 58 to lift away from the valve stem 56.

Once the diaphragm plate lifts from the stem, gas can travel through the center of the diaphragm plate and out the vent 60.

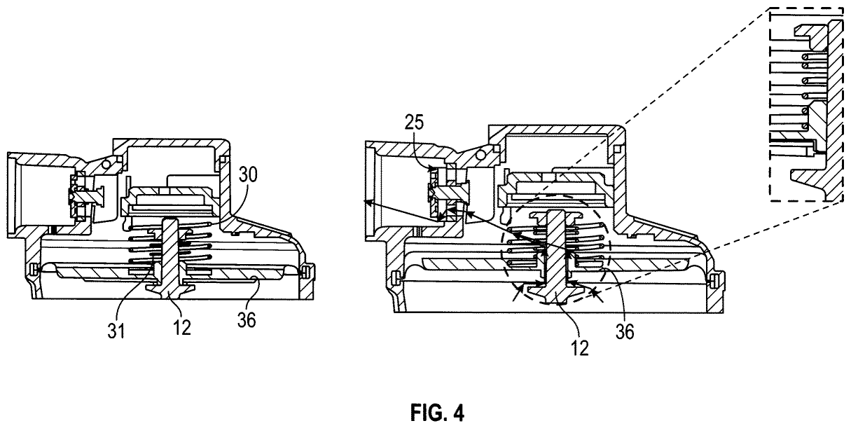

Referring to FIG. 4, as the diaphragm 36 compresses springs 30 and (IRV spring number 31) it moves from a closed position against the IRV seat on the stem 12 to an open position. Gas then flows through an opening in the diaphragm towards the vent outlet. This occurs with a dual stage regulator (see FIGS. 1-3) and a single stage regulator (see FIG. 5).

For a token IRV, the opening in the diaphragm plate is much smaller than with a standard IRV. One way this is possible because there is an integral slam shut valve. There is provided an Over Pressure Shut Off (OPSO) and an Under Pressure Shut Off (UPSO). Since the OPSO provides safety for the system, regulator doesn't require a full capacity IRV to safely operate.

If outlet pressure reaches the OPSO set point, the flow of gas is shut off at the inlet of the regulator. This requires a manual reset. OPSO is available standalone or with UPSO.

When the outlet flow of gas exceeds a set value of the maximum flow the excess flow device shuts off the downstream flow of gas. This would then activate the UPSO, requiring a manual reset.

In the event of a second stage diaphragm failure, the Safety Diaphragm will contain the gas and keep the regulator in operation. The safety diaphragm does not impact normal operation and provides an alarm through a limited release of gas to atmosphere.

This allows the relief to activate prior to the OPSO and prevent the OPSO from triggering due to minor upset conditions.

Many gas distribution companies require 3 feet of clearance for a regulator with a standard or token IRV which can result in problems for homes with a lot of windows, doors or vents.

The limited IRV functions the same as the standard IRV, but has been designed to minimize emissions. The Limited IRV is designed to limit the release of gas to <2.5 SCFH until the OPSO activates. These Limited IRVs are designed to release limited amounts of gas during minor upset scenarios. They do not provide over pressure protection and have no impact on regulator operation. The Limited IRV can be used to keep emissions at or below 2.5 SCFH until the OPSO activation point. The Limited IRV is available to minimize emissions for all delivery pressures.

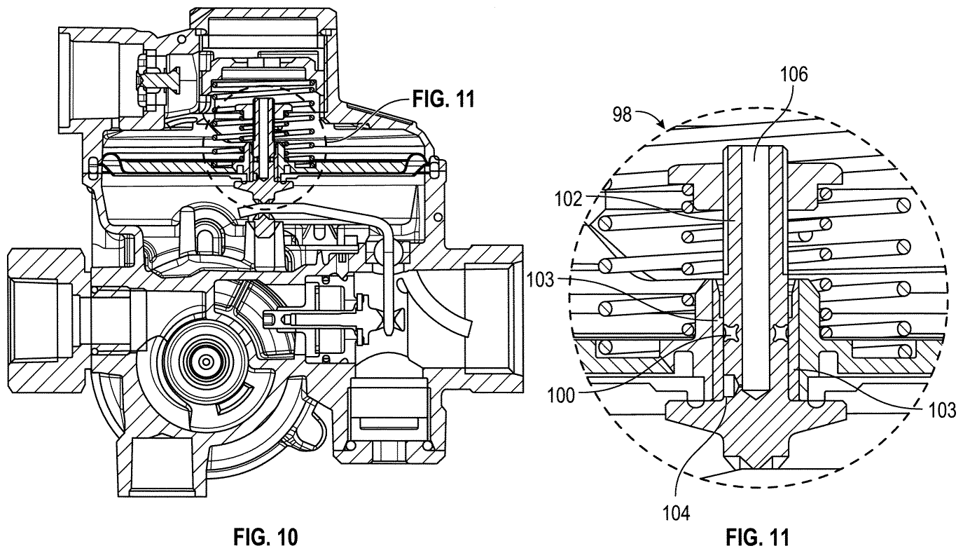

Referring now to FIGS. 9 and 11, an embodiment of a limited IRV in accordance with a preferred embodiment of the present disclosure is shown. This IRV may be used with a single stage regulator (see FIG. 5) and a dual stage regulator (see FIGS. 1-3 and 10).

The limited IRV 98 includes a valve stem 102 extending through diaphragm 110 that serves to minimize the flow area of the IRV and a bushing 103 which helps control the dimension inside the diaphragm plate 112. The diaphragm plate 112 is preferably plastic, while the bushing 103 is metal which aids in controlling the metal dimensions.

The embodiment includes a square or quad-ring 100 and channels or openings 104, 106 which are formed in valve stem 102. The square ring 100 has a substantially square cross-section which seals off the traditional flow path that is used in the token IRV and the Limited IRV design previously disclosed. The ring 100 prevents gas from flowing through the path around the outside of the valve stem 102.

Hole or channel 104 is a calibrated orifice drilled generally horizontally in relation to a longitudinal axis of the stem 102 through the stem. That is, holes 104 may be perpendicular to the longitudinal axis, at 45 degrees with respect to the longitudinal axis, or any other suitable orientation. The hole 104 is shown extending half way through the stem but may also extend completely through the stem. Drilling all the way through would create a “T” shaped path (along with hole 106) while drilling half way would create a preferred “L” shaped path (along with hole 106) (as shown in FIGS. 9-11). The hole 106 is also a calibrated orifice and is preferably drilled from the top of the stem down. Hole or channel 106 will then be formed along the longitudinal axis of the stem (i.e. vertically). The majority of the hole 104 will be drilled with a larger bit, and the final length of the hole will be drilled with a controlled diameter (see FIG. 11). This will allow finely controlling the flow area at the point of the controlled diameter. The diameter of hole 104 can be a variety of diameters as needed to limit the flow based on a certain range of pressures.

If outlet/delivery pressure continues to rise then the diaphragm will push up on the delivery spring and the IRV spring 108. This will compress these springs and allow the diaphragm 110 and diaphragm plate 112 to move up, exposing the horizontal holes or channels 104 in the stem 102. Gas can enter these channels 104 and will then turn by a designated amount and flow up through the stem via channel or hole 106. The diameter of the channel 104 flowing vertically through the stem 102 will be tightly controlled to limit flow to 2.5 SCFH of natural gas until outlet pressure reaches a point where the OPSO device will activate. A smaller diameter channel can be used for higher outlet pressures so that the maximum flow is still limited to 2.5 SCFH.

The disclosure has been described with respect to the preferred embodiments. Modifications and alterations may become apparent upon a reading and understanding of the preceding detailed description. It is intended that the disclosure encompass all such modifications and alterations such far as they come within the scope of the detailed description.

What is claimed is:

1. An internal relief valve assembly for use with a natural gas regulator, comprising:
a regulator having a diaphragm, a valve stem and an inlet for receiving gas;
a first spring which surrounds the valve stem and is centered in the diaphragm;
a second spring nested within said first spring for controlling when the internal relief valve will open;
a square-ring positioned within an opening within the valve stem;
a first channel formed in the valve stem; and,
a second channel formed in the valve stem which is substantively perpendicular to the valve stem and connected to the first channel to circulate the flow of gas through the valve to an outlet of the regulator.

2. The internal relief valve assembly of claim 1, wherein said first channel and said second channel control gas flow to 2.5 Standard Cubic Feet per Hour (SCFH) or less.

3. The internal relief valve of claim 1, further comprising a bushing surrounding the valve stem and the square-ring.

4. The internal relief valve of claim 1, wherein the valve stem extends through the diaphragm and serves to minimize the flow area of the internal relief valve.

5. The internal relief valve of claim 1, wherein the square-ring has a substantially square shaped cross section.

6. The internal relief valve of claim 1, wherein the square-ring seals off the flow path to prevent gas from flowing outside of the valve stem.

7. The internal relief valve assembly of claim 1, wherein the first channel is formed along a longitudinal axis of the valve stem.

8. The internal relief valve assembly of claim 7, wherein the second channel is formed perpendicular to the longitudinal axis of the valve stem.

9. The internal relief valve assembly of claim 8, wherein the first channel and the second channel form a substantially L-shaped channel.

10. The internal relief valve assembly of claim 8, wherein the second channel is formed through the stem on opposite sides of the first channel thereby forming a substantially T-shaped channel.

11. An internal relief valve assembly comprising:
a valve stem;
a bushing surrounding an outer portion of the valve stem;
a square-ring positioned in an opening formed around an outer portion of the valve stem;
a first channel formed in the valve stem which extends within a central portion of the valve stem along a longitudinal axis of the valve stem;
a second channel formed in the valve stem perpendicular to and connected to the first channel to circulate the flow of gas through the valve stem to an outlet of an associated gas regulator.

12. The internal relief valve of claim 11, wherein the diameter of the first channel is configured to limit gas flow based on a designated pressure.

13. The internal relief valve of claim 11, where said first channel and said second channel control gas flow to 2.5 standard cubic feet per hour (SCFH) or less.

14. The internal relief valve of claim 11, wherein the square-ring has a substantially square shaped cross section.

15. The internal relief valve assembly of claim 11, wherein the first channel is formed along a longitudinal axis of the valve stem.

16. The internal relief valve assembly of claim 11, wherein the first channel and the second channel form a substantially L-shaped channel.

17. The internal relief valve assembly of claim 11, wherein the second channel is formed through the stem on opposite sides of the first channel thereby forming a substantially T-shaped channel.
